(19) United States
(12) Patent Application Publication
(10) Pub. No.: US 2026/0049221 A1
(43) Pub. Date: Feb. 19, 2026

(54) METHOD FOR REDUCING RELATIVE RADAR PERMITTIVITY OF A COATING, RADAR TRANSMISSIVITY INCREASING COMPOSITIONS, COATINGS CONTAINING THE SAME, AND METHODS OF MAKING THE SAME

(71) Applicant: SWIMC LLC, Cleveland, OH (US)

(72) Inventors: Cindy BREUER, Lelystad (NL); Marianne VAN DUIST, Zeewolde (NL)

(21) Appl. No.: 19/298,594

(22) Filed: Aug. 13, 2025

Related U.S. Application Data
(60) Provisional application No. 63/682,478, filed on Aug. 13, 2024.

(51) Int. Cl. C09D 7/61; C08K 3/04; C08K 3/36; C08K 5/17; C09D 7/20; C09D 7/48; C09D 7/65

(52) U.S. Cl. CPC C09D 7/61; C08K 3/04; C08K 3/36; C08K 5/17; C09D 7/20; C09D 7/48; C09D 7/65

(57) ABSTRACT

A method of reducing relative radar permittivity of a coating composition is provided involving combining the coating composition with a silica to provide a radar-transmissive coating composition, wherein the silica is used in an amount sufficient to increase an amount of silica compared to silica in the coating composition by an amount of from 0.3 to 2.0 wt %, relative to total radar-transmissive coating composition, along with a radar transmissivity improving composition containing silica, and a method of preparing a radar-transmissive coating composition using the radar transmissivity improving composition.

### CROSS REFERENCE TO RELATED APPLICATIONS

The present invention is related to, and claims priority to, U.S. Provisional Application Ser. No. 63/682,478, filed Aug. 13, 2024, the contents of which are hereby incorporated by reference in their entirety.

### BACKGROUND OF THE INVENTION

### Field of the Invention

The present invention relates to methods and compositions for reducing the relative radar permittivity of a coating, and thus increase the radar transmissivity of the coating, particularly for use in coatings for vehicle parts installed over radar sensors.

### Description of the Related Art

The automotive industry uses radar sensors in passenger cars as part of their Advanced Driver Assistance Systems (ADAS). Further, EU Regulation No. 2019/2144 now requires all new vehicles registered in the EU to be equipped with radar sensors for traffic and pedestrian detection. Vehicle radar sensors can be separated into two categories: Short-range radar sensors which are effective up to 120 m distance and the long-range radar sensors which operate in a distance up to 300 m. The purpose of the radar sensors is for example cross traffic alert, adaptive cruise control and lane departure warning.

The passenger's safety is dependent on proper functionality of these sensors; therefore, it is important that the sensors can transmit and receive radar signals without hindrance and that there is no interaction with materials which are used to build the passenger car. Potential materials of concern in terms of radar permittivity are for example the plastic bumper and the OEM coating system as well as the refinish coating that is used to repair the plastic bumper in case of an accident.

The automotive radar band (radar signal) typically operates between 76-81 GHz and passes through the plastic bumper including the coating system (OEM or Refinish). This 1-way pass through the plastic bumper and coating is depicted in FIG. 1. The radar signal is then reflected by another car, or an object, and the radar sensor receives the reflected signal from the object in a second pass back through the plastic bumper including the coating system in the opposite direction, and the signal received is processed further. The radar signal thus always passes twice through the plastic bumper and the coating system when the radar signal is sent and received back.

The relative permittivity (εr) corresponds with how easy a sample is polarized by the electromagnetic waves of the radar signal. This polarization of the sample causes the radar signal to be reduced or “damped”, resulting in a lower radar signal intensity.

The maximal radar signal intensity correlates with 100% power. The radar signal is an electromagnetic wave that can interact in three different ways with material. In an ideal situation, the radar signal (electromagnetic wave) passes through a sample without any interaction like reflection and/or absorption and thus is not reduced or “damped”.

The following formula can be used to define the power of the radar signal intensity passing through a sample:

100% Power=Transmission (%)+Reflection (%)+Absorption (%)
Transmission=no influence on the radar signal intensity
Reflection=lowers the radar signal intensity
Absorption=lowers the radar signal intensity

Coatings, and particularly automotive coatings, are dielectric layers, and the polarization is studied in bulk due to the inhomogeneous nature of the coatings (resin, additives, pigments). During the polarization, the sample stores electrical energy by frequency dependent charge shifting. The field orientation changes for example 76,500,000,000 times per second at 76.5 GHz. The loss tangent (tan δ) is an imaginary part loss that describes the power intensity reduction by absorption which is caused by the charge shift.

Currently, automotive OEMs have no uniform specifications and test methods for radar permittivity. Some automotive OEMs are still in the process of evaluating which relative permittivity is acceptable with respect to the proper functionality of the radar sensors behind the coated plastic bumper. In general, the lower the relative permittivity and the lower the loss tangent the better.

Unfortunately, many coatings, particularly automotive coatings, contain pigments that severely impact radar transmissivity. Therefore, may such coatings require reformulation in order to be radar compliant. However, reformulating such coatings often affects the color match of the coating. Accordingly, much effort is directed to reformulating these coatings to be radar compliant without sacrificing the color match, which can be a quite challenging and time-consuming process.

Thus, from a paint supplier and raw material supplier perspective, the automotive industry currently has no direct solution to address the influence of the automotive coating system on radar signal intensity. One approach being tried is to replace metallic pigments (aluminum) with white micas in the highest amount possible without influencing the color matching. However, this requires considerable reformulation efforts for each coating color, often with varied results.

Accordingly, there is a need for a method of reducing relative radar permittivity of a coating composition that can retain the original pigments of the coating, while reducing radar permittivity and thus increasing radar transmissivity of the resulting coating, without significantly affecting the color match of the resulting coating.

### SUMMARY OF THE INVENTION

One object of the present invention is to provide a method for reducing relative radar permittivity of a coating composition while retaining the color match of the resulting coating, without the need to change the pigments used in the coating composition.

A further object of the present invention is to provide a radar transmissivity improving composition which can be combined (as an additive or as a binder) with existing coating compositions to improve the radar transmissivity properties of the coating composition.

Another object of the present invention is to provide methods for the preparation of radar-transmissive coating compositions using the radar transmissivity improving composition.

These and other objects and advantages of the invention, either alone or in combinations thereof, may be satisfied by a method of reducing relative radar permittivity of a coating composition, comprising:
combining the coating composition with a silica to provide a radar-transmissive coating composition, wherein the silica is used in an amount sufficient to increase an amount of silica compared to silica in the coating composition by an amount of from 0.3 to 2.0 wt %, relative to total radar-transmissive coating composition;
a radar transmissivity improving composition comprising the silica; and methods for preparing the radar-transmissive coating composition using the same.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 provides a representation of the 1-way pass of the automotive radar band (radar signal) through the plastic bumper and coating on a radar sensor.

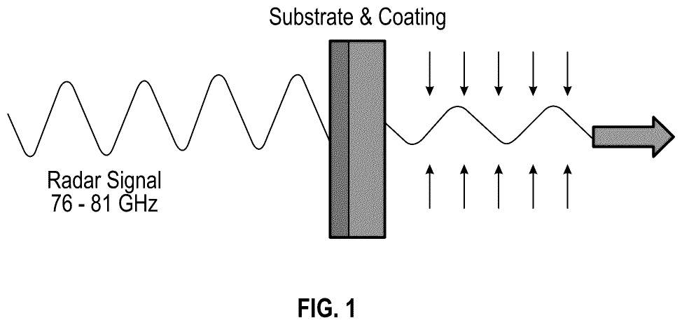

FIG. 2 provides a representation of the isolation and spacing that occurs as particles of silica (round particles) intersperse between radar critical pigments (the rectangular particles) to create spacing between those radar critical pigments and help to isolate them from one another.

FIG. 3 provides a representation of the change in relative permittivity in a composition containing a metallic toner by addition of differing amounts of the radar transmissivity improving composition of certain embodiments of the present invention.

### DETAILED DESCRIPTION OF THE PREFERRED EMBODIMENTS

Embodiments identified herein as exemplary are intended to be illustrative and not limiting. Within the context of the present invention coating composition, the use of “wt %” refers to the weight percent of the component in the wet formation of the composition (as opposed to the dry formulation after drying of the coating).

In certain embodiments, the present invention relates to a method for reducing the relative radar permittivity of a coating composition while retaining the color match of the resulting coating, preferably without the need to change the pigments used in the coating composition. In certain embodiments, the present invention relates to a radar-transmissivity improving composition which can be combined (either as an additive or a binder) with a coating composition to improve the radar-transmissivity of the resulting coating, preferably without affecting the color match properties of the coating and preferably without the need to alter the underlying coating pigment formulation.

In the coating industry, particularly in vehicle coatings/automotive coatings, the biggest influence factor on radar permittivity for radar sensors is the pigmented basecoat, applied on the vehicle parts installed over or in front of the radar sensors, which provides the actual car color of an automotive coating system. This applies to both waterborne basecoats as well as solvent borne basecoats. The radar measurements for the automotive OEM's demonstrate that similar colors in different basecoat types/qualities (water- and solvent borne) show similar relative permittivity. For other pigmented coating systems like primers and surfacers, there are also similar correlations found as for the pigmented waterborne basecoats.

The following are radar critical pigments that have an influence on the radar permittivity, from high (Metallics) to low (Oxide yellow, red, brown). Other tested pigments showed minor to no significant influence (at least not to an extent that it would risk passenger safety):

### Radar Critical Pigments

Metallics (Aluminum)
Micas/Xirallics (Post treated with titanium dioxide or iron oxide)
Post treated pigments with titan dioxide show a higher er than pigments post treated with iron oxide.
White (Titan dioxide)
Glass flakes (Silicon dioxide)
Black (Carbon)
Yellow (Bismuth vanadate)
Oxide yellow, red, brown (Iron oxide)

In particular, the Metallic (Aluminum) and Black (Carbon) pigments are the main ones that show a significant contribution to power loss by absorption of the radar signal as it passes through coatings containing such pigments.

The present inventors have found that the addition of silicon dioxide (SiO₂) (also referred to herein as silica) to a coating composition that contains radar critical pigments reduces the overall relative permittivity of the coating formed. Without wishing to be bound to a particular theory or mechanism of action, it is believed that the silicon dioxide particles increase the spacing between radar critical pigments, such as metallics (aluminum), and work like an isolator which reduces the polarization by electromagnetic waves.

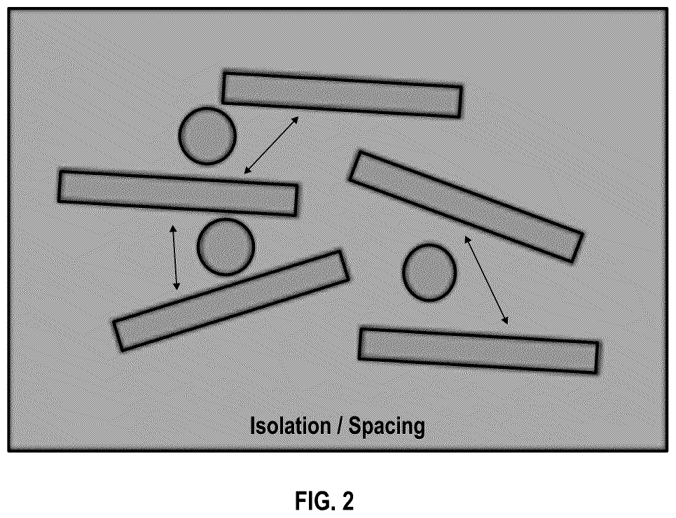

This is illustrated in FIG. 2, which shows the isolation and spacing that occurs as the silicon dioxide (round particles) intersperse between the radar critical pigments (the rectangular particles) to create spacing between those radar critical pigments and help to isolate them from one another. This isolation and spacing effect is most effective for coatings that are easy to polarize and have a high relative permittivity. These coatings with a high relative permittivity contain radar critical pigments that have a smaller standardized distance to each other. With a decreasing initial relative permittivity, the effectiveness of silica as an isolator and insulator decrease as well. This is believed to be caused by the larger standardized distance between the radar critical pigments of these coatings. The amount of binder (or non-radar critical toner) gives sufficient standardized distance between the radar critical pigments, so that it overrules the additional spacing, isolation and insulation effect that the use of silicon dioxide SiO₂ provides. This is shown in the following Table 1. However, even with a lower initial relative permittivity, the effect of the addition of silica on reducing relative permittivity, while reduced, is still significant.

TABLE 1
Effectiveness of silica is dependent
on the initial relative permittivity.

| | | |
|---|---|---|
| Initial Relative Permittivity | 102.7 | 52.5 |
| without silica added | | |
| Amount silica active added | 0.5% | 0.5% |
| (wt %) | | |
| Final Relative Permittivity | 59.4 (Δ 43.4) | 42.6 (Δ 9.9) |

While this same isolation effect can also be achieved by adding a transparent binder or a wax additive, each of which also extend the spacing between the radar critical pigments and serve as an isolator, the advantage of adding silica instead of a transparent binder is that the amounts of silicon dioxide required are much less. This is particularly beneficial for the overall hiding power, the paint consumption and number of layers required during the application of the coating composition product. The disadvantages of wax are potential inter-coat adhesion failures, the wax is typically not fully transparent, and the particle size tends to be larger which influences the metallic orientation and therefore tends to adversely affect the color match. Without being bound by a particular theory, it is believed that the effectiveness of the silica additive SiO₂ is driven by isolation (creating distance/spacing between pigment particles) and insulation (preventing transfer of electrical charge between conducting particles) effects, while wax is more reliant on the isolation effect to reduce the overall relative permittivity. Thus, silica is overall the better choice to reduce the relative permittivity of a coating system without influencing the color match compared to a wax additive which tends to adversely affect color. The use of a wax additive instead of silica has a disadvantage that it disorients the metallic effect pigments, which makes it less effective as a post add solution to current basecoat formulations without major reformulation, which is one of the primary advantages of the silica containing compositions of the present invention. Further, while a wax additive may provide lower relative permittivity compared to the use of silica, the wax additive has a greater tendency to adversely affect the color match of the coating, thus requiring the reformulation of the coating composition in order to arrive at a color match. With that said, however, it is possible for the present invention coating compositions to optionally comprise an amount of less than 20 wt %, preferably less than 10 wt %, more preferably less than 5 wt % of a wax. The wax in such embodiments can be micronized or non-micronized, or can be a paraffin or polyethylene based wax, and is preferably used in an amount that would further lower the relative permittivity compared to the coating with silica alone, while having minimal or no adverse impact on the color match of the coating.

A comparison of the relative Flop Index in % (a measurement of change in reflectance of a metallic color as it is rotated through the range of viewing angles) of coating compositions of the present invention containing silica and a comparative composition containing only wax particles, relative to a control coating composition containing neither. The % flop compared to the Standard with 5% additive for both solid colors (black and blue) was measured. They show similar trends, confirming that the wax additive disorients the metallic effect pigment stronger than the silica additive (silica containing inventive composition average=90.3-104%; wax containing composition average 64.5-99.4% of the original flop index from the standard). These tests also confirmed that the mean of the flop index of the silica additive of the present invention composition is not significantly different to 100% (standard without modification) with a p-value of 0.337. On the other hand, the flop index mean of the wax additive deviates significantly and is not equal to the standard of 100% with a p-value of 0.005. Accordingly, the silica containing compositions of the present invention provide a superior combination of radar permittivity and color match as compared the use of a wax additive alone.

In certain embodiments, the present invention provides a method of reducing relative radar permittivity of a coating composition, comprising:
combining the coating composition with a silica to provide a radar-transmissive coating composition, wherein the silica is used in an amount sufficient to increase an amount of silica compared to silica in the coating composition by an amount of from 0.3 to 2.0 wt %, relative to total radar-transmissive coating composition. Even if the original coating composition already contains an initial small amount of silica (typically less than about 1.2 wt %), the present method can provide improvements by reducing relative radar permittivity of the coating composition.

The coating composition with which the silica is combined can be a waterborne coating composition or a solvent borne coating composition. This coating composition can be any conventional coating composition, and is particularly a coating composition used in the automotive/vehicle industry for coating vehicle parts, particularly plastic parts, that are installed over or in front of radar sensors. Such vehicle parts include, but are not limited to, vehicle grills, radomes, or vehicle company logos. The coating composition can contain any conventional coating components, including but not limited to, dispersants, surfactants, binders, additives, resins, etc.

In preferred embodiments, the coating composition is a waterborne coating composition, which is becoming a preferred type of coating for use in the automotive industry due to health and environmental concerns.

In certain preferred embodiments of the present method, the silica is used in an amount sufficient to increase the amount of silica by an amount of from 0.4 to 0.7 wt %, relative to total radar-transmissive coating composition. In more preferred embodiments, the silica is used in an amount sufficient to increase the amount of silica by an amount of about 0.5 wt %, relative to total radar-transmissive coating composition.

In certain embodiments of the present method, the coating composition comprises one or more radar critical pigments, preferably one or more pigments selected from metallic pigments and carbon pigments. In preferred embodiments of the present method, the one or more pigments comprise at least one aluminum-containing pigment or at least one carbon containing pigment.

When performing the above-described method, the silica can be combined with the coating composition in any desired manner, so long as the silica is substantially homogenously dispersed throughout the resulting radar transmissive coating composition. While it is possible to add the silica to the coating composition as a powder, doing so is more difficult due to the high shear rates that are required to fully incorporate the silica in powder form, which may also destroy the effect pigments contained in the coating composition. Accordingly, using a dispersion or suspension of the silica is preferred. Due to the hydrophobic nature and high surface area of silica, the silica is preferably combined with the coating composition as such a dispersion or suspension.

In certain embodiments of the present invention, the invention relates to a radar transmissivity improving composition comprising silica, a dispersant, and water. This radar transmissivity improving composition is preferably a dispersion (sometimes referred to as a “radar additive” or stabilized as a binder (sometimes referred to as a “radar binder”). This radar transmissivity improving composition can be used as the silica in the above-described method, thus combining with the coating composition as either a binder or an additive.

In certain embodiments of the present radar transmissivity improving composition, the silica is present in an amount of from 5 wt % to 30 wt % based on total composition amount. In certain embodiments, the radar transmissivity improving composition is a binder composition and the silica is present in an amount of from 5 wt % to 20 wt % based on total composition amount. In other embodiments, the radar transmissivity improving composition is an additive and the silica is present in an amount of from 10 to 30 wt % based on total composition amount.

In certain embodiments of the present radar transmissivity improving composition, the composition further comprises one or more members selected from the group consisting of co-solvents, stabilizers, neutralizers, flow additives, leveling additives, and resins. In certain preferred embodiments of the present radar transmissivity improving composition, a stabilizer is present. In certain preferred embodiments, the stabilizer is dimethylethanolamine (DMEA). In other embodiments, a neutralizer is present, such as an amino alcohol like DMEA or 2-amino-2-methyl-1-propanol.

In certain embodiments of the present radar transmissivity improving composition, the radar transmissivity improving composition has a pH of greater than 7, preferably from 10 to 11.

In certain embodiments, the invention relates to a method of preparing a radar-transmissive coating composition, comprising:
combining a coating composition with any of the radar transmissivity improving composition described above to provide the radar-transmissive coating composition, wherein the amount of radar transmissivity improving composition used is sufficient to increase an amount of silica compared to amount of silica in the coating composition by an amount of from 0.3 to 2.0 wt %, relative to total radar-transmissive coating composition.

As noted above, the coating composition with which the radar transmissivity improving composition is combined can be a waterborne coating composition or a solvent borne coating composition. This coating composition can be any conventional coating composition and is particularly a coating composition used in the automotive/vehicle industry for coating vehicle parts, particularly plastic parts, installed over or in front of radar sensors. The coating composition can contain any conventional coating components, including but not limited to, dispersants, surfactants, binders, additives, resins, etc.

The coating composition of the present invention can be applied to a surface using any desired application method, including, but not limited to spray application, draw down application, brush application, or dip application.

In certain preferred embodiments of this method, the radar transmissivity improving composition is used in an amount sufficient to increase the amount of silica by an amount of from 0.4 to 0.7 wt %, more preferably by an amount of about 0.5 wt %, relative to total radar-transmissive coating composition.

In certain embodiments of this method, the coating composition comprises one or more radar critical pigments, preferably one or more pigments selected from metallic pigments and carbon pigments. In preferred embodiments of the present method, the one or more pigments comprise at least one aluminum-containing pigment or at least one carbon containing pigment.

The silica used in the present invention methods and compositions preferably has a primary particle size ranging from 5-200 nm to prevent influence on the metallic orientation (color match). For pigmented basecoats that usually do not exceed a dry film thickness of about 25 μm, fine silica grades are preferred. The silica can be any desired particulate form of silica, including but not limited to fumed silica, silica aerogel, precipitated silica, amorphous silica, or colloidal silica.

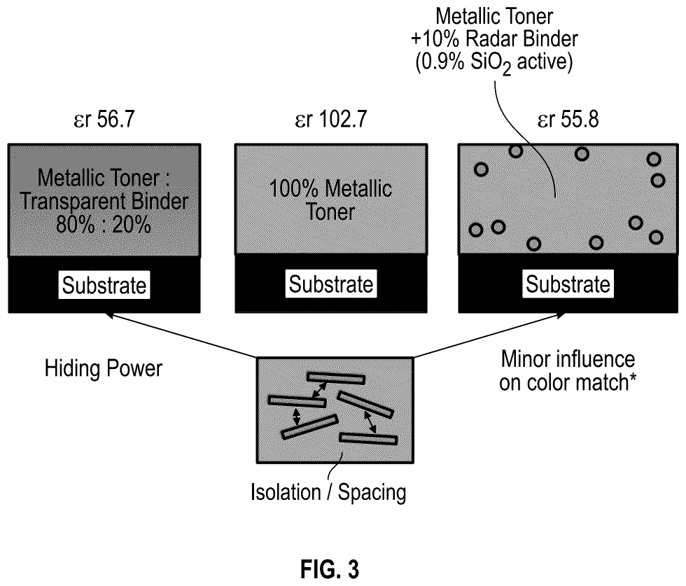

As depicted in FIG. 3, the addition of the radar transmissivity improving composition of the present invention in an amount sufficient to provide ca. 0.9% silica active (+10% radar binder containing silica, dispersant and water) reduces the relative permittivity from 102.7 to 55.8 in a typical metallic (aluminum) pigment basecoat. Adding ca. 0.5% silica active (+5% radar binder) or ca. 1.7% silica active (+20% radar binder) shows no significant improvement for the relative permittivity, with the relative permittivity only decreasing slightly with more silica (0.5% εr=59.4/0.9% εr=55.8/1.7% εr=51.2). The amount of silica is less significant than the overall presence of silica in the sample at all. The influence on the color is barely visible up to 2 wt % silica, as confirmed by multi angle color measurements. The addition of more than 2 wt % silica (corresponding to 20-30% radar binder) is not recommended due to its effect of lowering hiding power and therefore requiring higher paint consumption and number of layers required during application.

In a further embodiment, the addition of ca. 0.5% silica active reduces the relative permittivity from 52.4 to 42.6 in a conventional automotive silver metallic basecoat color that has not been optimized for radar by replacement of the metallic pigment with mica. The influence on the color is negligible, as indicated by color measurements. Adding the silica in the form of a radar additive (containing 10-30 wt % silica, water, dispersant, neutralizer, and optional resin to stabilize the silica) also does not influence the spray characteristics of the resulting silver metallic basecoat color coating composition. Because the starting relative permittivity is lower in this instance (at 52.4), the effectiveness of adding silica as an isolator is less, but it still provides an overall lower relative permittivity to the resulting composition, without the need to reformulate, while retaining the desired color match.

Radar measurements are performed as detailed in EP 4113745 (the contents of which are incorporated herein by reference in their entirety) with the RMS-D (Radome Measurement System) Desktop unit available from Perisens, GmbH, which can perform the following measurements and calculations:
Relative Permittivity (εr)
Transmission 1-way (dB)
Transmission 1-way Calc. (dB)
Transmission 1-way (°)
Loss Tangent (tan δ)
Reflection calc. bottom and top (dB)
Absorption bottom and top (dB)

Of these, the most informative radar measurements for the present invention are relative permittivity (εr), transmission 1-way (dB) and loss tangent (tan δ).

The following are exemplary embodiments of the present invention:

Embodiment 1. A method of reducing relative radar permittivity of a coating composition, comprising:
combining the coating composition with a silica to provide a radar-transmissive coating composition, wherein the silica is used in an amount sufficient to increase an amount of silica compared to silica in the coating composition by an amount of from 0.3 to 2.0 wt %, relative to total radar-transmissive coating composition.

Embodiment 2. The method of Embodiment 1, wherein the coating composition is a waterborne coating composition.

Embodiment 3. The method of one of Embodiment 1 or Embodiment 2, wherein the silica is used in an amount sufficient to increase the amount of silica by an amount of from 0.4 to 0.7 wt %, relative to total radar-transmissive coating composition.

Embodiment 4. The method of any one of Embodiments 1 to 3, wherein the silica is used in an amount sufficient to increase the amount of silica by an amount of about 0.5 wt %, relative to total radar-transmissive coating composition.

Embodiment 5. The method of any one of Embodiments 1 to 4, wherein the coating composition comprises one or more pigments selected from metallic pigments and carbon pigments.

Embodiment 6. The method of Embodiment 5, wherein the one or more pigments comprise at least one aluminum-containing pigment.

Embodiment 7. The method of Embodiment 5, wherein the one or more pigments comprise at least one carbon pigment.

Embodiment 8. The method of any one of Embodiments 1-7, further comprising addition of a wax.

Embodiment 9. A radar transmissivity improving composition comprising silica, a dispersant, and water.

Embodiment 10. The radar transmissivity improving composition of Embodiment 9, wherein the silica is present in an amount of from 5 wt % to 30 wt % based on total composition amount.

Embodiment 11. The radar transmissivity improving composition of one of Embodiment 9 or Embodiment 10, wherein the radar transmissivity improving composition is a binder composition and the silica is present in an amount of from 5 wt % to 20 wt % based on total composition amount.

Embodiment 12. The radar transmissivity improving composition of any one of Embodiments 9 to 11, further comprising a stabilizer.

Embodiment 13. The radar transmissivity improving composition of Embodiment 12, wherein the stabilizer is dimethylethanolamine (DMEA).

Embodiment 14. The radar transmissivity improving composition of any one Embodiments 9 to 13, wherein the radar transmissivity improving composition has a pH of greater than 7.

Embodiment 15. The radar transmissivity improving composition of any one of Embodiments 8 to 13, wherein the radar transmissivity improving composition has a pH of from 10 to 11.

Embodiment 16. The radar transmissivity improving composition of any one of Embodiments 9-10 or 12-15, wherein the radar transmissivity improving composition is an additive and the silica is present in an amount of from 10 to 30 wt % based on total composition amount.

Embodiment 17. The radar transmissivity improving composition of any one of Embodiments 9 to 16, further comprising a neutralizer.

Embodiment 18. The radar transmissivity improving composition of any one of Embodiments 9 to 17, further comprising one or more members selected from the group consisting of co-solvents, flow additives, leveling additives, and resins.

Embodiment 19. The radar transmissivity improving composition of any one of claims 9 to 18, further comprising a wax.

Embodiment 20. A method of preparing a radar-transmissive coating composition, comprising:
combining a coating composition with the radar transmissivity improving composition according to any one of Embodiments 9 to 19 to provide the radar-transmissive coating composition, wherein the amount of radar transmissivity improving composition used is sufficient to increase an amount of silica compared to amount of silica in the coating composition by an amount of from 0.3 to 2.0 wt %, relative to total radar-transmissive coating composition.

Embodiment 21. The method of Embodiment 20, wherein the coating composition is a waterborne coating composition.

Embodiment 22. The method of one of Embodiment 20 or Embodiment 21, wherein the radar transmissivity improving composition is used in an amount sufficient to increase the amount of silica by an amount of from 0.4 to 0.7 wt %, relative to total radar-transmissive coating composition.

Embodiment 23. The method of any one of Embodiments 20 to 22, wherein the radar transmissivity improving composition is used in an amount sufficient to increase the amount of silica by an amount of about 0.5 wt %, relative to total radar-transmissive coating composition.

Embodiment 24. The method of any one of Embodiments 20 to 23, wherein the coating composition comprises one or more pigments selected from metallic pigments and carbon pigments.

Embodiment 25. The method of Embodiment 24, wherein the one or more pigments comprise at least one aluminum-containing pigment.

Embodiment 26. The method of Embodiment 24, wherein the one or more pigments comprise at least one carbon pigment.

Obviously, numerous modifications and variations of the present invention are possible in light of the above teachings. It is therefore to be understood that within the scope of the appended claims, the invention may be practiced otherwise than as specifically described herein.

1. A method of reducing relative radar permittivity of a coating composition, comprising:
combining the coating composition with a silica to provide a radar-transmissive coating composition, wherein the silica is used in an amount sufficient to increase an amount of silica compared to silica in the coating composition by an amount of from 0.3 to 2.0 wt %, relative to total radar-transmissive coating composition.

2. The method of claim 1, wherein the coating composition is a waterborne coating composition.

3. The method of claim 1, wherein the silica is used in an amount sufficient to increase the amount of silica by an amount of from 0.4 to 0.7 wt %, relative to total radar-transmissive coating composition.

4. The method of claim 1, wherein the silica is used in an amount sufficient to increase the amount of silica by an amount of about 0.5 wt %, relative to total radar-transmissive coating composition.

5. The method of claim 1, wherein the coating composition comprises one or more pigments selected from metallic pigments and carbon pigments.

6. The method of claim 1, further comprising addition of a wax.

7. A radar transmissivity improving composition comprising silica, a dispersant, and water.

8. The radar transmissivity improving composition of claim 7, wherein the silica is present in an amount of from 5 wt % to 30 wt % based on total composition amount.

9. The radar transmissivity improving composition of claim 7, wherein the radar transmissivity improving composition is a binder composition and the silica is present in an amount of from 5 wt % to 20 wt % based on total composition amount.

10. The radar transmissivity improving composition of claim 7, further comprising a stabilizer.

11. The radar transmissivity improving composition of claim 10, wherein the stabilizer is dimethylethanolamine (DMEA).

12. The radar transmissivity improving composition of claim 7, wherein the radar transmissivity improving composition has a pH of greater than 7.

13. The radar transmissivity improving composition of claim 7, wherein the radar transmissivity improving composition is an additive and the silica is present in an amount of from 10 to 30 wt % based on total composition amount.

14. The radar transmissivity improving composition of claim 7, further comprising a neutralizer.

15. The radar transmissivity improving composition of claim 7, further comprising one or more members selected from the group consisting of co-solvents, flow additives, leveling additives, and resins.

16. The radar transmissivity improving composition of claim 7, further comprising a wax.

17. A method of preparing a radar-transmissive coating composition, comprising:
combining a coating composition with the radar transmissivity improving composition according to claim 7 to provide the radar-transmissive coating composition, wherein the amount of radar transmissivity improving composition used is sufficient to increase an amount of silica compared to amount of silica in the coating composition by an amount of from 0.3 to 2.0 wt %, relative to total radar-transmissive coating composition.

18. The method of claim 17, wherein the coating composition is a waterborne coating composition.

19. The method of claim 17, wherein the radar transmissivity improving composition is used in an amount sufficient to increase the amount of silica by an amount of from 0.4 to 0.7 wt %, relative to total radar-transmissive coating composition.

20. The method of claim 17, wherein the coating composition comprises one or more pigments selected from metallic pigments and carbon pigments.
